(19) United States
(12) Patent Application Publication
(10) Pub. No.: US 2005/0016056 A1
(43) Pub. Date: Jan. 27, 2005

(54) Method for controlling pests using ground glass

(76) Inventors: James E. Pelot, Lewisville, NC (US); Stephen Z. Baxter, Dallas, NC (US)

Correspondence Address: WOMBLE CARLYLE SANDRIDGE & RICE, PLLC, P.O. BOX 7037, ATLANTA, GA, 30357-0037, US

(21) Appl. No.: 10/872,753

(22) Filed: Jun. 21, 2004

Related U.S. Application Data
(63) Continuation of application No. PCT/US02/40908, filed on Dec. 19, 2002.
(60) Provisional application No. 60/343,408, filed on Dec. 21, 2001.

(51) Int. Cl. A01M 1/00; A01M 17/00

(52) U.S. Cl. 43/132.1

(57) ABSTRACT

The present invention provides a method for controlling snails and slugs by applying a composition comprising finely ground glass particles. The glass particles can include a specially formulated glass.

This application is a continuation of PCT/US02/40908 filed Dec. 13, 2002, which claims benefit of U.S. Provisional Patent No. 60/343,408, filed Dec. 21, 2001.

### DETAILED DESCRIPTION OF THE INVENTION

Unlike some products typically used for controlling snails and slugs or other pests, the compositions of the present invention are non-toxic to plants and animals. The compositions pose no significant environmental hazard and can be handled without any special precautions.

The compositions can comprise finely ground, recycled glass or specially formulated glasses. The term “finely ground glass” includes glass particles having an upper size defined by particles that pass through a 30 mesh screen but are retained on a 50 mesh screen and a lower size defined by particles that pass a 50 mesh screen but are retained on a 400 mesh screen.

When the composition is spread as a barrier in a location where it is desirable to exclude snails, slugs, and the like, including many types of insects, e.g., around the base of vegetation, the composition provides an exclusion zone that slugs or snails will not cross, or that will reduce the number of snails and slugs that traverse the area. When the glass is no longer visible, a re-application is necessary.

Further, it is not necessary to remove the glass because it will eventually mix with the soil and act as a natural soil aerator. Also, certain compositions of the invention comprising specialty glass can act as a fertilizer. The exact composition of the glass is not important except that the glass has some solubility in soils and, in some embodiments, can contain potassium and phosphorous, allowing the composition to act as a fertilizer.

In a particular embodiment of the invention, the composition comprises a specially formulated glass from a binary mixture of potassium and phosphorus or ternary mixture of potassium, phosphorus and either calcium or silica. Alternatively, the composition can also comprise a quaternary composition of potassium, phosphorus, calcium, and silica. These compositions are particularly well suited to provide a fertilizer as an additional benefit. In areas that have high alkali soils, a low alkali glass such as e-glass may be used.

After the glass is manufactured or obtained as a by-product from a suitable source, e.g. as a recycled product, it is then ground and becomes suitable for both snail and slug control as well as a fertilizer.

Accordingly, in one aspect, the invention relates to a method for controlling pests comprising applying finely ground glass particles to the area where an infestation of the pests has occurred or is possible. The pests can be invertebrates, including arthropods (e.g. insects such as ants), or gastropods such as snails and slugs. The glass particles can be recycled glass. The glass can also be a specially formulated glass including a composition selected from the group consisting of a binary mixture of potassium and phosphorus; a ternary mixture of potassium, phosphorus and silica; a ternary mixture of potassium, phosphorus, and calcium; and a quaternary mixture of potassium, phosphorus, calcium, and silica. In other embodiments, the glass particles can be e-glass.

In another aspect, the invention relates to a kit for controlling pests, comprising a container suitable for holding finely ground glass particles; finely ground glass particles; and instructions for applying the glass particles to an area in need of pest control. The glass particles can have an upper size defined by particles that pass through a 30 mesh screen but are retained on a 50 mesh screen and a lower size defined by particles that pass a 50 mesh screen but are retained on a 400 mesh screen.

It will be realized that suitable glass according to the principles of the invention may be determined without undue experimentation. The glass compositions provided herein are intended to provide examples for the purposes of illustration.

1. A method for controlling pests comprising applying finely ground glass particles to the area where an infestation of the pests has occurred or is possible.

2. The method of claim 1, wherein the pests are invertebrates.

3. The method of claim 2, wherein the invertebrates are arthropods.

4. The method of claim 3, wherein the arthropods are insects.

5. The method of claim 2, wherein the invertebrates are gastropods.

6. The method of claim 5, wherein the gastropods are selected from the group consisting of snails and slugs.

7. The method of claim 1, wherein the glass particles are recycled glass.

8. The method of claim 1, wherein the glass particles are e-glass.

9. The method of claim 1, wherein the glass particles comprise a specially formulated glass including a composition selected from the group consisting of a binary mixture of potassium and phosphorus; a ternary mixture of potassium, phosphorus and silica; a ternary mixture of potassium, phosphorus, and calcium; and a quaternary mixture of potassium, phosphorus, calcium, and silica.

10. The method of claim 1, wherein the glass particles have an upper size defined by particles that pass through a 30 mesh screen but are retained on a 50 mesh screen and a lower size defined by particles that pass a 50 mesh screen but are retained on a 400 mesh screen.

11. A kit for controlling pests, comprising
a) a container suitable for holding finely ground glass particles;
b) finely ground glass particles; and
c) instructions for applying the glass particles to an area in need of pest control.

12. The kit of claim 11, wherein the glass particles have an upper size defined by particles that pass through a 30 mesh screen but are retained on a 50 mesh screen and a lower size defined by particles that pass a 50 mesh screen but are retained on a 400 mesh screen.

13. The kit of claim 11, wherein the glass particles are recycled glass.

14. The kit of claim 11, wherein the glass particles are e-glass.

15. The kit of claim 11, wherein the glass particles comprise a specially formulated glass including a composition selected from the group consisting of a binary mixture of potassium and phosphorus; a ternary mixture of potassium, phosphorus and silica; a ternary mixture of potassium, phosphorus, and calcium; and a quaternary mixture of potassium, phosphorus, calcium, and silica.

16. A kit for controlling pests, comprising
a) a container suitable for holding finely ground glass particles;
b) finely ground glass particles; and
c) instructions for applying the glass particles to an area in need of pest control, wherein the glass particles have an upper size defined by particles that pass through a 30 mesh screen but are retained on a 50 mesh screen and a lower size defined by particles that pass a 50 mesh screen but are retained on a 400 mesh screen, and wherein the glass particles are selected from the group consisting of recycled glass, e-glass, glass comprising a binary mixture of potassium and phosphorus; glass comprising a ternary mixture of potassium, phosphorus and silica; glass comprising a ternary mixture of potassium, phosphorus, and calcium; and glass comprising a quaternary mixture of potassium, phosphorus, calcium, and silica.
